(19) United States
(12) Patent Application Publication
(10) Pub. No.: US 2013/0316044 A1
(43) Pub. Date: Nov. 28, 2013

(54) BREAD HAVING IMPROVED TEXTURE AND TASTE AND METHOD FOR PRODUCING SAME

(71) Applicant: José María Fernández Capitán, Pozuelo De Alarcon (ES)

(72) Inventor: José María Fernández Capitán, Pozuelo De Alarcon (ES)

(73) Assignee: Mark Licency International, S.L., Madrid (ES)

(21) Appl. No.: 13/983,838

(22) PCT Filed: Jul. 17, 2012
(86) PCT No.: PCT/ES2012/070542

§ 371 Date: Aug. 6, 2013

(30) Foreign Application Priority Data
Jul. 28, 2011 (ES) P 201131295

(51) Int. Cl. A21D 8/04

(52) U.S. Cl. CPC A21D 8/042
USPC 426/20; 426/549; 426/497

(57) ABSTRACT

The invention relates to bread having improved texture and taste and to the method for producing same, specifically to a bread obtained from wheat flour, having a reddish, crunchy crust, and prepared from pieces of precooked dough kept frozen until final baking, and to said pieces of precooked dough. The pieces of precooked dough are obtained from a dough that is a mixture of wheat flour, water, salt, liquid yeast and an improver comprising less than 5% of both hemicellulase and alpha-amylase, and of ascorbic acid and L-cysteine, by means of a method that includes kneading, resting, shaping, fermenting, cutting to form the slit, precooking and chilling. The precooked dough is preferably kept frozen until the bread is to be consumed, at which time it is baked at a temperature higher than usual for 2 minutes to 3 minutes 30 seconds.

### TECHNICAL FIELD

The present application relates to a novel type of bread developed to achieve texture and porosity characteristics which make it particularly palatable and in addition, facilitate its storage under frozen conditions at a stage prior to that of the final product, the final product reaching the consumer being very easy and quick to prepare from the fermented and baked dough which was previously kept frozen. The application also relates to a method for producing the fermented and baked dough, prepared in order to be kept in frozen conditions as well as to the entire method also including the step of obtaining the final product from said fermented dough.

### BACKGROUND OF THE INVENTION

Bread is the product obtained from cooking a portion of shaped dough in an oven, mixing in water and grain flour. In general, said dough is subjected to a fermentation process prior to being cooked, brought about by the addition of yeasts to the dough, producing an increase in its volume and the formation of a fluffy structure. This spongy structure increases in size during the cooking process, to which it is subsequently subjected, and is called the crumb in the final product. The spongy structure is surrounded at the end of the cooking process by a crystalline and crunchy outer layer in the form of a crust. There is also a less common variety on the market known as unleavened bread, which is bread made without adding the yeasts to the dough.

The pieces may be in different shapes and sizes, including the very popular elongated loaf of bread, but there are also trapezoidal and circular shapes. Often the pieces in these shapes, in particular the elongated and trapezoidal shapes, have grooves or indentations in the surface, which are called slits. These result from cutting the surface of the preformed dough after fermentation and prior to cooking. There is also a variety of bread known as sliced bread, obtained by introducing the dough into a mold prior to cooking. This bread has an exterior crust that is much less hard and crunchy, more flexible, with a crumb with a greater content of water and is usually sold packaged.

The characteristic holes in the crumb of the bread are called alveoli. Their size and distribution are typical of each product as is the color and thickness of the crust.

Wheat is the main breadmaking cereal of all the known cereals, as its flour has some unique properties which facilitate the shaping of the dough when it is mixed with water and, above all, it has a unique capacity for retaining the gas produced during the fermentation of the flour, which after cooking, allows to obtain a more spongy structure than with the flour of other cereals. The rest of the bread types are made from flours of other cereals, although they often include a proportion of wheat flour. Within the wheat flour, there are, in turn, differences in behavior during the breadmaking process, primarily due to its levels of protein. In addition to the differences which exist between the flours due to the different varieties of wheat from which they are made, the qualities of the flours undergo variation with each season due to the fact that the qualities and characteristics of the cereals change according to the climatic conditions, the soil and the purity of the varieties used.

The fundamental ingredients required for producing bread are: water, flour and yeast (Saccharomyces cerevisiae). In addition, salt is the fourth ingredient, which may be considered fundamental in order for the final product to be acceptable for the western consumer. Other ingredients such as oil, sugar, milk solids or various additives (antioxidants such as ascorbic acid, substances to control mold growth such as calcium propionate, surfactants such as a-monoglycerides) may be also added. The different proportions of the fundamental ingredients, the mixture or not of flours from different cereals, the cooking process and the presence or not of other additional ingredients produce different varieties of bread which may be commercially available or which may be consumed in restaurants and canteens.

As mentioned, the qualities of the flour used are going to be characteristics with great influence both in the production process of the bread and in the characteristics of the final product obtained. Therefore, it is very important to check the characteristics of the flour used and, if necessary, to act on the parameters, which do not respond precisely to the desired values.

Among the most important characteristics to be checked in the flour for breadmaking processes are: the capacity to retain water, volume yield, machinability (a concept related, amongst others, to parameters such as energy consumption required to handle a material in the relevant machinery or the waste produced thereby), the fermentation tolerance of the dough (capacity to form a sufficiently strong structure to retain the gas but, at the same time, with flexibility such that the piece may increase in size without breaking or deforming) and the rheological parameters of the dough resulting from the same, namely, its capacity to tolerate stretching during the kneading process. It is common to use a device called an alveograph to verify these parameters. This device carries out tests with doughs comprising flour, water and, usually salt, acting on pieces of dough inflated with pressurized air, simulating the deformation which the dough undergoes as a result of the gases generated during the fermentation process, thus reproducing the behavior of an alveolus in the dough. The device records curves, known as alveographic curves or alveograms, an example of which is shown in FIG. 1. It is possible to deduce the five most important rheological parameters of the flour from these curves, which are:
The tenacity (P) or resistance to stretching, usually expressed in millimeters (mm), and it is the distance from the highest point of the curve to the x-axis. It is the maximum pressure, which the dough tolerates before deforming, evaluated in millimeters in a water column, and indicates the resistance of the dough to breakage.
The extensibility (L), which is the length of the curve, the length of the horizontal axis of the mean alveogram, measured to the breakage point. It is also expressed in millimeters.
The flexibility (p′), which is the height of the graph at the breakage point of the dough, also expressed in millimeters and denotes the pressure at the breakage point of the dough bubble.
The strength or stretch of the flour (W) corresponds to the area included between the curve of the alveogram, the y- and x-axes and the vertical line corresponding to the breakage point. It corresponds to the strength required to knead the flour: the greater the alveographic curve, the greater W is and the greater the amount of energy required to knead the flour. This is associated with the amount and characteristics of the proteins contained within the flour. The quaintly and quality of the wheat proteins, the gluten proteins, is what makes wheat the reference cereal for products with a spongy crumb.
The ratio of tenacity to extensibility (P/L), which is the ratio of the resistance shown by the dough to being stretched to the stretching capacity. This is a particularly important parameter.

The optimum value for the P/L parameter depends on the type of bread and the length of the loaves. As a general rule, the flour used for hard doughs must be more tenacious than extensible and the optimum P/L ratio is approximately 0.45/0.50; the flour for soft doughs must be more extensible than tenacious and the optimum P/L ratio is approximately 0.35/0.40.

Since the characteristics of the flours vary according to the seasons, it is important to treat the flour in such a way so as to compensate for the fluctuations and to make the production process as uniform as possible. Different improvers stand out as being amongst the ingredients most commonly used to improve the quality of the flour, such as L-cysteine and various enzymes such as for example, hemicellulases and alpha-amylases as well as additives such as emulsifiers or anticaking agents.

The term hemicellulase denotes a family of enzymes whose members are all capable of breaking down the pentosans, which are polysaccharides present in wheat flours; they receive this name because they produce pentoses when disintegrated. It is supposed that the pentosans form a network with the gluten such that the more pentosans there are, the firmer the network, giving rise to less volume yield and a more densely structured crumb. Treating any flour using hemicellulases thus gives rise to a considerable increase in volume yield, also influencing water retention and the structure of the dough. However, it is difficult to further specify the influence of the hemicellulases in general over the breadmaking process because the points at which the hemicellulases attack the pentosan molecules vary widely according to the origin thereof. This is one of the reasons why it is difficult to find general recommendations regarding dosage. There also exists no standardized method for determining the activity of these enzymes, thus making it very difficult to establish relationships between the various methods currently available for determining the activity, which are based on determining different parameters such as the release of reducing sugars, the reduction in viscosity or the disintegration of synthetic or colored molecules.

The majority of commercially available hemicellulases are obtained from the fungi of the genus Aspergillus. They are mainly sold mixed with amylases. The amount in which they are added varies, in general, between 4 g and 15 g per 100 kg of flour.

The amylases are also enzymes that are frequently added: obtaining bread with a very spongy crumb and a reddish crust depends on having an accurate balance in the action of the alpha- and beta-amylases in the flour and during the breadmaking process. They are vital in providing the suitable supply of energy to the yeast, which must obtain the energy required for the cellular activity of the free sugars present in the dough, preferably glucose. However, in order for the yeasts to obtain all the energy they require, the starch must be broken; the amylases are capable of carrying out this process, thus making it possible to release units of maltose, sugar formed from two units of glucose. The amylases are found naturally in wheat grain, which means that the energy stored in the starch granules may be released, which energy is required by the embryo in order to develop and produce new wheat plants. However, it may be expedient to add commercial amylases in the breadmaking process in order that the amylolysis, the process of breaking down the starch, is more complete and increases the energy available to the yeasts responsible for the fermentation. This is the case, in particular, as the production of CO₂ is proportional to the velocity of maltose formation by the amylases.

There are two type of amylases: the alpha-amylases (which break 1,4 inner bonds of starch chains, producing smaller fragments, called dextrins) and beta-amylases (which work from the non-reducing ends of the starch molecules, producing units of maltose, which may also take place directly starting from the amylose and amylopectin chains of starch, or from the dextrins released by the alpha-amylases). The maltose is the most important component of the low molecular weight fraction resulting from the amylolysis; once it has been transported to the interior of the yeast cells, it may be split into two glucose molecules, the basic raw material for the alcoholic fermentation, which produces the carbon dioxide required for the development of the dough.

The level of beta-amylases of the flours is always sufficient for correct breadmaking, but its activity (the production of maltose) is partially conditioned by the level of alpha-amylase in the dough. Thus, when the natural amylases content of the flour is low, adding fungal amylase at the beginning of the kneading process improves the velocity of maltose formation. However, an excess of dextrins causes the crumb to become sticky, for example, and the crust to have a reddish color, which is unpleasant for the consumer. This is why the best technical results are achieved when there is a balance of alpha- and beta-amylases. The usual dosage of alpha-amylases is 1 g-3 g per 100 g of flour.

With regard to the amino acid L-cysteine, it is added when it is desired to increase the extensibility of the dough, but not its tenacity. This achieves, amongst other improvements, a reduction in the kneading time and improves the processability of the dough. The amounts in which it is added depend on the specific commercial forms used (since the percentages between the hydrochloride and anhydrate forms vary from one to the other); however, it may be between 1 g and 5 g per 100 g of flour.

Another standard ingredient is ascorbic acid (E-300): it is the most commonly used additive for some producers in European breadmaking. Ascorbic acid is an antioxidant, however, it quickly converts into an oxidant of the dough (dehydroascorbic acid), specifically of the protein network thereof by means of the enzymes present in the flour (ascorbic oxidase). The properties of the dough thereby improve, thus enabling an increase in volume, water retention capacity and tenacity and flexibility of the dough and a reduction in extensibility. This also produces a whiter crumb with more uniformly distributed alveoli as well as a whiter and shinier crust. It is unusual for the dosage to exceed 20 g per 100 g of flour, although current legislation allows for the addition of the amount which is considered appropriate.

The use of emulsifiers and anticaking agents is also common. Emulsifiers are compounds with a hydrophilic end and a lipophilic end and thus facilitate the mixing of water with lipophilic substances. Adding emulsifiers to the bread dough (for example, in an amount of 5% by weight) gives rise to a greater volume, a more softly structured crumb and greater duration. Two types of emulsifiers are common in bread production, emulsifiers which make the dough firm and add volume (for example monoacetyl and diacetyl tartaric esters (E472e) and sodium and calcium stearoyl 2 lactylate (E481 and E482)) and those which soften the dough, producing a softer crumb and bread with greater duration (for example mono- and diglycerides of fatty acids (E471), the total concentration of which may not exceed 3 g per 1 kg of flour).

With regard to the anticaking agents, they prevent the clumping of the flour. Calcium carbonate (E-170i) is the most widely used and there is no permitted limit on the amount that is added to the bread, rather the amount which is deemed appropriate may be added in accordance with good production practices.

Just as important as the ingredients for making the bread is the processing to which it is subjected and the correct handling thereof: the kneading time and the final temperature of the bread as well as the prefermentation, shaping, fermentation and cooking conditions must be devised and controlled with care.
Kneading: it must be carried out in the time required for the diffusion of the water in the flour particles to take place, thus completely hydrating the flour. If the water is not well distributed, the yeast will not act correctly and there will be differences in texture in the different sections of the bread. The kneading time and conditions must be such that they allow the total diffusion of the water in the flour and a cohesive and somewhat flexible dough to be obtained, which is called the development of the dough. When the dough is well developed, it can be left over the edge of a table and will not fall off. The optimum kneading time must not be exceeded because this gives rise to a sticky and moist dough. The kneading time varies considerably according to the characteristics of the flour, in particular, the protein percentage (flours with a protein percentage less than 12% require longer kneading times) and the type of kneader selected: spiral kneaders achieve a rapid kneading (less than 10 minutes), although the dough heats up more (the temperature increases to 10° C. above room temperature), whereas arm kneaders require between 18 and 30 minutes to knead the same dough, although they cause less reheating, and oblique shaft kneaders have a low level of reheating but also knead slowly. Excessively long and/or intense kneading causes greater oxygenation of the dough, with whitening of the crumb and a notable loss of taste and smell. With regard to the final temperature, it is not recommended that it exceeds 26° C. as this leads to an increase in oxidation, which influences the whitening of the crumb.
Fermentation: During this stage, the yeast begins to release carbon dioxide after consuming the oxygen present in the dough, the size thereof thus increases and becomes spongy. The temperature of the dough is important because although the activity of the yeasts is at its maximum at 35° C., thereby concluding the fermentation process more quickly, bad odors are produced which is why it is recommended that fermentation takes place without exceeding 27° C., leaving a resting time of approximately two hours. Depending on the alveoli desired in the crumb, it may be of interest to prolong the fermentation time as this produces larger and more unevenly distributed alveoli; whereas a low-intensity fermentation gives the crust a reddish tone. In accordance with all of the above, the fermentation of the white bread is carried out with little yeast and in a short time, preventing the loss of homogeneity in the size and distribution of the alveoli; however candeal bread undergoes a longer fermentation, which favors the uneven distribution of alveoli of different sizes.
Baking: Cooking the bread is always carried out in an oven. Standard cooking is carried out at temperatures between 185° C. and 250° C. The duration of baking may be between 10-20 minutes for small breads and up to one hour for large breads. The cooking time, the temperature and the temperature profiles selected for baking are not only important for determining the characteristics of the bread, but the relative humidity in the oven is also important as this is going to influence, amongst other characteristics, the formation of the crust: low relative humidities (less than 75% to 80%) produce fine crusts, while higher relative humidities cause a thicker formation of the crust. The initial contribution of vapor, in addition, partially hydrates the starch of the external layer, which produces the glaze on the surface of the bread. During the cooking process, in addition to the expansion of the gas, there is a large solubilization of the starch due to the increase in enzymatic activity (between 50 and 80° C.), the coagulation of the gluten (upon the dough reaching temperatures of 60-80° C.), the dehydration of the crust due the water transfer in the form of vapor (at 100° C.), the formation of brown dextrin in the crust (130° C. to 140° C.), the caramelization and development of the Maillard reaction (chemical reaction between the proteins and the reducing sugars caused by heating foodstuffs) with browning of the crust (140° C. to 150° C.), and the appearance of dark brown color on the surface (150° C. to 200° C.). If the dough reaches the temperature of 200° C., it carbonizes, the piece appearing porous and black. In addition to influencing the characteristics of the crust, it is important to check that the relative humidity is suitable according to the characteristics of the dough as blisters may be produced.

A breadmaking process carried out correctly from a dough with flour having suitable characteristics produces a bread with a soft crumb and a crunchy crust, that is to say, it crunches when being chewed. The taste of the bread has a lactic tone, which is pleasant to the palate. In order to obtain a good crumb and the correct crust, part of the water, which evaporates from the surface during cooking, must be retained in the crumb.

The characteristics of the bread must be maintained for as long as possible during storage. However, the loss in the quality of the bread, termed ageing, starts as soon as it is taken out of the oven. It fundamentally consists of the increase in the toughness of the crust, due to the increase in the percentage of water in the latter and to an increase in the compactness of the crumb, due to the recrystallization of the starch. This may be counteracted by subjecting the bread to reheating, which from 65° C. up to about 90° C.-100° C., causes the crystallized starch fractions to combine and lose rigidity, thus even recovering part of the smell and taste the bread had before ageing. The softening is only temporary as the heating causes dehydration, which facilitates the recrystallization of the amylopectin. Mitigating the disadvantages caused by the ageing of the bread is also one of the reasons why attention must be paid to the selection of the ingredients, the optimization of formulae and the selection of the processing conditions.

Breadmaking by baking in two steps is an alternative to reheating, which has been used with success in order to reduce the losses in the bread due to ageing. This breadmaking method consists of preparing the bread following the steps of a traditional process until fermentation. In this case, the fermented doughs are partially baked, that is to say, they are baked until the crumb is formed but before the development of the color of the crust begins. The partially baked bread has a white aspect (the crust has not formed) and a greater moisture content than completely baked bread. The partially baked bread is stored under conditions which guarantee its stability (refrigeration or freezing) until the time it is needed; the second baking step is then carried out and the breadmaking process is complete, thus obtaining a bread with similar characteristics to the fresh product.

In Spain and in other Mediterranean countries, the bread has been a fundamental part of the diet for generations. It was still common in the first decades of the 20^{th} century, particularly in rural environments, for families to have ovens in which to prepare their own breads, which were generally breads using hard doughs with a low percentage of water. The fermentation of these breads was carried out with little yeast and in a short space of time (called white bread), which was kept for a number of days under suitable conditions in order to be consumed. The migration of families to the cities limited the preparation of bread to specialized establishments using ovens with the capacity for a number of pieces who supplied the bread to stores, which specialized in its sale i.e. bakeries. The type of bread most widely consumed became a bread using softer dough, with a higher level of hydration, requiring the consumer to purchase bread on a daily basis as the compactness of the crumb could hinder its insalivation and deglutition after 24 hours had passed since coming out of the oven, depending on the climatic conditions of the location. The ciabatta type of bread is amongst the most popular bread using a softer dough. It is a bread with a soft dough and a longer fermentation, and thus has a more uneven distribution of alveoli of different sizes.

Nowadays, consumption habits are such that the consumption of bread in restaurants and cafeterias is becoming increasingly greater. The consumer enters these places expecting to find bread with optimum characteristics in terms of taste, texture, color, and level of hydration of the crumb and crust, etc., whatever the time of day. This is the case, in particular in establishments where the bread is an integral part of the basic products being consumed, such as establishments for the sale and consumption of sandwiches and different varieties thereof which are essentially obtained after separating the bread into two parts by cutting into the latter in a plane parallel to the surface on which it was deposited during cooking. The need to have breads with characteristics similar to those of bread which has been recently made at any time of the day, has led to the introduction of a step of freezing the bread, carrying out a final cooking step shortly before offering the bread to the consumer. Unfortunately, the steps of freezing and thawing assume one more factor which influences the quality of the final product that reaches the consumer which is why special attention must be paid when not only selecting the conditions of freezing and thawing, but also when selecting the ingredients of the bread and the formulations, such that they are more suitable for minimizing the disadvantages associated with the freezing and thawing processes and the level of deterioration which may affect the quality of the final product.

Bread or raw bread dough (ready to be fermented or ready to be shaped) may be frozen. Freezing precooked dough is also popular, the latter having been subjected to cooking which may have taken place at temperatures similar to those typical of the normal preparation of bread (185° C. to 210° C., for example), but which has been stopped when the crust is still white or slightly yellow, while the expansion of the gases and the inhibition of the yeast has actually been completed. After thawing the dough, it is subjected to the final reheating process, producing bread ideal for consumption. Thawing may be carried out at room temperature (a process which may involve one hour at 15° C. to 20° C. as guideline values), or in the case of dough that needs fermenting, it may be carried out at a higher temperature, at the temperature selected for the fermentation (for example 30° C. to 32° C.), leaving it to ferment for 1.5 to 2 hours at that temperature. Another option is to thaw the bread at refrigeration temperature (from 0° C. to 5° C.), which may take around 6 hours in the case of small breads with the characteristics of a small baguette. This may facilitate keeping the bread in said refrigeration conditions for various days (which generally may not exceed 5 days) until the final bread needs to actually be prepared. However, this last option may give rise to breads without the texture required by the consumer if the preservation time has been excessive and, in addition, involves having an additional device suitable for maintaining the raw or precooked dough under refrigeration conditions.

When it is desired to obtain the final bread, ready for consumption, it needs to be subjected to the final baking process. In the case of baking precooked dough, the final cooking time will logically be less than in normal baking. Typical conditions for final baking may be 185° C. for 15 minutes, it not being advisable to increase the temperature much more than this, as it is likely that this will cause the bread to appear burned. Thus, obtaining the bread from precooked dough, also requires the dispatch point of the bread to have an oven in which to carry out the final baking process. It will take an average of 15 minutes until the final product may be obtained and a new batch of pieces of precooked dough may be then introduced into the oven.

Freezing bread or raw or precooked dough has many advantages, but also some disadvantages. On the one hand, freezing and/or thawing may negatively affect the texture. It is recommended to use stronger flours with a greater protein content in order that the structure of the dough better tolerates said steps of the process, although bread with the texture desired by the consumer is not always achieved. In addition, using this method not only assumes that the establishments, in which the bread will ultimately be consumed, have chambers to keep the bread frozen until the final product is required, but rather necessitates a very careful selection of the times at which the precooked dough begins the steps which lead to obtaining the final product, very accurately calculating the pieces to be processed at each moment and waiting a minimum time of around fifteen minutes from the time the final product is required (when it is introduced into the oven chamber) to the time it is actually ready to be available to the public. This finalized bread, whose preservation as precooked dough involved an additional cost in order to be kept under freezing conditions and carry out the baking, must be consumed within a period of a few hours after being baked as it starts to age rapidly, thus being rejected by the consumer.

The selection of the formulation of ingredients most suited for being able to freeze the bread, the decision of the time during the process of preparing the bread, in which the bread is frozen and the final thawing conditions and cooking conditions of the latter, are critical for obtaining good quality bread with characteristics that not only make it acceptable for the consumer, but also, preferably, which give it a special identity, which may help the consumer to associate the bread with the establishment in which it is consumed, and which thus aids customer loyalty. It is not plain and simple to identify a formulation and a method, which produce a bread with the characteristics sought, which may, in addition, be kept frozen until the time the final product needs to be produced. It is even more difficult to identify a manner of reducing the final cooking time required for the final product to be made ready to be served and under conditions acceptable for the consumer. This impedes a suitable flow of sale and reduces the productivity of the final product and the ability to respond to isolated increases in the needs for bread with sufficient speed. The present invention presents a starting formulation, a method for producing bread and a bread obtained by the same method, which solves those problems, obtaining, in addition, a bread with a texture, aspect and taste, which are very appealing to the consumer.

### DESCRIPTION OF THE INVENTION

The present invention relates to a bread having an improved texture, well suited for satisfying the current tastes of consumers, ideal for consumption both in sandwich form (particularly, small sandwiches called “montaditos”), both cold as well as hot, or as an accompaniment to dishes, the bread being obtained from a precooked dough, which may be kept at freezing temperature for months and which, after final baking, produces a product having the desired characteristics of a crunchy crust and a soft and fluffy crumb when being insalivated and chewed in the mouth, but at the same time, is crunchy when it is bitten. This bread is obtained owing to the composition of the starting formulation and by means of the process to which the mixture of the starting ingredients is subjected until achieving a precooked dough, which is frozen, and which is subsequently subjected to a process of reheating in order to obtain the final product. The invention relates both to the precooked dough, which is frozen, and to the final product obtained from the latter, as well as to the method by which said products are obtained.

The bread according to the invention and the process by which it is obtained have various peculiarities with respect to the bread products and their normal processes of preparation.

a) When the precooked dough has thawed, the final baking thereof may be carried out at a temperature above the standard temperature, 240° C., without the bread becoming burned or carbonized, as would happen with standard doughs, but rather it has a texture and aspect which are very appealing to the consumer, with a crunchy, fine and crystalline crust and a slightly golden coloration. This is the result of the development of a suitable Maillard reaction in just 2 minutes. This increase in temperature of final baking makes it possible for it to be carried out in less than 5 minutes (between 2 and 3 minutes 30 seconds, according to the size of the piece), that is, with much more speed than normal baking of the precooked dough (which takes place at about 185° C. for about 15 minutes, given as average guideline values). This facilitates an increase in the speed of preparation of the final bread, which achieves an increase in the flow of sales and facilitates a rapid response at the times when there is a greater influx of customers and a larger quantity of bread must be made available in a short space of time, since there is greater capacity to prepare bread in less time.

b) The preservation time of the precooked dough thawed in the refrigerator is also above the standard time: it is possible to keep the dough for 15 days at 5° C. without the organoleptic qualities of the final product (color, taste, odor, texture) becoming negatively affected. In this way, in the event that the units of bread to be thawed have not been suitably calculated, the latter may be kept for longer in the refrigerator without this affecting the quality of the final product which reaches the consumer.

c) In the event that the final bread is not consumed within a few hours, thus starting to age, it would be possible to bake it a second time, equally quickly as it may be carried out at a high temperature (265° C., 30-60 seconds), producing a rejuvenated bread, which is very appealing to the customer. This makes it possible to provide aged bread in the case that more units were prepared than were ultimately consumed within the optimum time.

The invention, therefore, enables bread having very good organoleptic qualities to be obtained, the method of production of which and the preservation characteristics of which facilitate the response to the fluctuations which may be caused through the consumption requirements: a bread, well-preserved as refrigerated precooked dough, capable of being prepared in a short space of time in a final baking process and being able to tolerate a quick second baking, producing a product which is pleasing to the customer, in the event that the final bread has not been consumed prior to the beginning of the ageing process.

This bread is prepared from the following formulation, in which the amount of each component is expressed as the amount added for each 100 kg of flour:

| | |
|---|---|
| Wheat flour | 100 kg |
| Water | 55.7 kg-58 kg |
| Salt | 1.8 kg |
| Yeast (Saccharomyces cerevisiae) | 0.8 kg-1.2 kg |
| Improver | 0.7 kg-1.2 kg |

wherein the flour has a strength of 230-275 mm and a ratio of tenacity to extensibility (P/L) comprised in the range of 0.5-0.75 and the improver comprises:

hemicellulase: <5% (weight/weight)

alpha-amylase: <5% (weight/weight)

ascorbic acid: <5% (weight/weight)

L-cysteine: <5% (weight/weight) an emulsifier and an anticaking agent.

This produces a dough having 55.7% maximum hydration.

With regard to the flour, it is preferable for it to have a protein concentration of 12-13% and a moisture content not exceeding 15%. A specific guideline value which is preferred for the protein concentration is 12.8%. With regard to the ratio of tenacity to extensibility (P/L), 0.55 is the suitable guideline value. With regard to the strength, 270 mm is quite a suitable value.

Within the above formulation, 0.95 kg-1.05 kg per 100 kg of flour is the preferred range for the amount of improver.

The emulsifier is preferably E472e (monoacetyl tartaric and diacetyl tartaric) and the anticaking agent is E170i (calcium carbonate). Provided that the limits permitted by legislation are not exceeded (reference is made to the good production practices with respect to E170i), the amount of any of these additives is not critical for obtaining the breads according to the invention with the desired characteristics. As guideline values for the purposes of the invention, the emulsifier E472e preferably constitutes 10-18% of the total improver, while the anticaking agent E170i constitutes 8-16% of the total improver. The sum of the ascorbic acid and L-cysteine preferably does not exceed (or is less than) 5% in relation to the total of the improver. With regard to the enzymes, the sum of the hemicellulase and the alpha-amylase preferably does not exceed 5% in relation to the total of the improver.

The improver may also comprise wheat flour (36-44% being the preferred percentage by weight with respect to 100 g of total improver) and wheat semolina (28-36% similarly being the preferred percentage by weight with respect to 100 g of total improver).

Table 1 below thus shows a possible formulation for the improver suitable for the present invention:

TABLE 1
Possible composition of the improver

| | Amount of improver per 100 |
|---|---|
| Improver ingredient | g (percentage by weight) |
| Wheat flour | 36-44% |
| Wheat semolina | 28-36% |
| Emulsifier: E472e | 10-18% |
| Anticaking agent: E170i | 8-16% |
| Flour treatment agent: | ≦5% |
| ascorbic acid + L-cysteine | |
| Enzymes: hemicellulase + alpha-amylase | ≦5% |

A formulation with specific amounts is detailed in Example 1, both for the total amount of the improver and the exact percentages of its ingredients with respect to the total improver as well as the remaining components of the dough.

The formulation ingredients described above, the formulation of the invention with all the possible variants shown above and the proportions in which they are combined in said formulation, are very important for obtaining the final product, the bread having the desired characteristics as well as for enabling the intermediate precooked bread dough, prepared from said formulation having the desired characteristics which will give rise to the characteristics of the bread which is ultimately obtained. However, a careful selection and checking of the suitable processing conditions is required in order to correctly carry out the method with this formulation to obtain, firstly, the precooked dough, and ultimately, the piece of bread ready to be consumed having the desired characteristics. To this end, care must be taken both with respect to the correct dosage of the ingredients and with observing the processing conditions selected for each of the steps of the process according to the invention. This process is especially designed for obtaining, firstly, the precooked dough, and subsequently, the bread which is ready to be consumed. A method for preparing the bread comprising the following steps thus constitutes one aspect of the invention:

a) Dosing the ingredients of the formulation according to the invention into a container;

b) Kneading the mixture of the above ingredients;

c) Leaving the dough to rest;

d) Shaping individual pieces from the dough;

e) Leaving the dough to ferment;

f) Making oblique cuts in the surface of the fermented dough;

g) Precooking the fermented dough;

h) Cooling.

These steps enable a piece of precooked bread dough to be obtained, the intermediate product which sets the conditions for the characteristics of the final bread obtained as well as the conditions under which its processing may be carried out.

The pieces preferably sought when implementing the process according to the invention are pieces not exceeding 50 g in weight: this is the preferred maximum weight for the individual pieces formed in step d). The conditions in the remaining steps are adjusted, taking into account said preferred characteristic for the pieces.

The steps performed in order to obtain the precooked dough are preferably specifically carried out under the following conditions:
Kneading: 5.6±3 minutes, using a spiral kneader which rotates at 165±5 rotations/min. (Final temperature of the dough: 23.7±0.7° C.).
Resting: 5±3 minutes
Shaping: rectangular pieces of approximately 45.5±2 grams
Fermentation: 112±2 minutes at 25° C.±1° C.
Cutting: 2 oblique cuts (which will produce the appearance of the corresponding slit in the surface of the final piece)
Precooking: 15.5 minutes, in two modules, each one of which being of the same duration, wherein the temperatures vary in the following manner: module 1: 165° C. to 180° C., module 2: 175° C. to 160° C. and the percentage of vapor 7±3% in module 1 and 0% in module 2. That is to say, in these types of ovens, the cooking temperature is not constant, but rather varies in each module; in the first module, it starts at 165° C., it increases up to 180° C. and then the temperature decreases again to 165° C.; in the second module, it starts at 165° C., it increases up to 175° C. and the temperature is allowed to gradually decrease to 160° C.
Cooling: 20±0.5 minutes, at room temperature.

The precutting of the product is preferably carried out during the cooling step. The precutting is preferably specifically a type of hinge cut. This is understood to mean making a cut parallel to the base of the precooked dough which is not a complete cut separating the precooked dough into a base and upper piece, but rather they preferably remain joined at one of the lateral ends of the piece, such that the piece may be opened as if it were a book: this means that both parts of the piece do not separate when being handled, thus facilitating processing. Specifically, the lateral cut is particularly preferably carried out with a hinge of 10%, that is to say, a cut that does not extend the whole width of the piece, but rather leaves about 10% of the total width uncut.

The method according to the invention also preferably includes an optional additional step in which the surface of the product is marked. From a commercial point of view, this has the advantage that it encourages the consumer to associate the excellent organoleptic characteristics of the final product with the distinctive sign marked on the loaf. The consumer thus develops a stronger association between the bread, the place where the final product was consumed and the excellent properties including the color, taste texture, etc., for which the bread is recognized. There are different systems for including marks on foodstuffs which remain on the final product reaching the consumer, such as for example, food dyes which are common in the meat sector, or by means of stickers adhered to the surface.

The marking step may take place at different times during the method according to the present invention. It is particularly preferably carried out after exiting the precooking stage, that is to say, during the cooling. Said marking is particularly preferably carried out by means of a laser system, more specifically, a 100 W laser system with a wavelength of 10.6 μm, in which the optics and scanners are, for example, arranged on split heads. The S-3100 PLUS SHS from MACSA ID (Manresa, Barcelona) is an example of equipment with such characteristics, connected to a computer control system having a complete graphical interface including Marca™ software that facilitates the design of the distinctive sign selected. In order for the system to be compatible to the fullest extent with the method previously described, (as well as with the specific implementation described further on in the Example of the present application), the use of a laser system with 4 heads is preferred, as the product in the preferred implementations of the method according to the invention, will reach the laser in trays, in which the portions of precooked dough will be arranged in 4 rows. In a preferred implementation, the system is designed so that the tray stops upon arriving at the marking zone, the laser equipment moving above the product in a dynamic manner until completing the distinctive sign selected. One possibility to this end, is that the X-axis is positioned by mean of a programmable system, while the settings for the Y- and Z-axes are carried out by means of manual adjustment (spindles). The system preferably includes a photocell (such as for example an OMRON E3Z-D81) below each laser, which effectively identifies that there is a piece of precooked dough below the laser in such a way that it will send an error message and prevent the actuation of the laser, if the piece of precooked dough is not present or is placed incorrectly on the tray, thus avoiding the tray becoming damaged. If a piece of precooked dough is present, the simultaneous course of the four lasers will initiate. The lasers are preferably aided by a linear guiding system transversally along the length of the structure which allows the simultaneous displacement of the four lasers towards each other as a function of the marking program. When the distinctive sign selected has been completed, the displacement of the lasers ends and the tray is released, with the system left waiting for the next tray.

FIG. 2b shows an example of a piece of bread ready for consumption, obtained by the method according to the invention, which was marked with a laser once it had been precooked, as explained in the previous paragraph. As may be seen in the present example, the loaf has been marked with letters and numbers (“100M” to be precise), which is one of the possible alternatives although any other sign may be used.

As previously mentioned, the specific characteristics of the piece of precooked dough obtained, directly depends on the ingredients used to prepare the dough and the proportions in which each of these are added as well as the specific conditions applied in the steps of kneading, resting, shaping, fermentation, cutting of the surface, precooking and cooling as they will set the conditions for the characteristics of the dough, the amount of gas obtained by fermentation, its distribution and the adaptation of the dough to the increase in volume and evaporation of the gas produced. These pieces of precooked dough obtained by applying the method according to the invention also constitute an aspect of the invention. In this case, it is preferred that these pieces of precooked dough obtained are 36 g-44 g in weight, 12.8 cm±0.7 cm in length, 4.4 cm±0.3 cm in width and 2.9 cm±0.2 cm in height.

As has been mentioned, the method according to the invention is designed, such that in one of the preferred embodiments, the pieces of precooked dough obtained are not directly subjected to final heating after cooling in order to obtain the final piece of bread ready for consumption, but rather said pieces of precooked dough are preferably subjected to a freezing stage in order to be maintained in that state until the time they may be required to be thawed. In particular, freezing preferably takes place for 37 minutes at −25° C.±1° C.

The process is preferably carried out in one continuous automated system, in which the various pieces of machinery carrying out each step (kneading, shaping, fermentation chamber, precooking oven, and cold storage chamber) are connected by a system of belts and lifts automatically transporting the pieces to each of the stages once the predefined dwell time in each machine has elapsed.

The prefrozen precooked dough may be kept in this manner for at least three or four months. It is preferably kept at between −22° C. and −18° C., it not being recommended to exceed to the temperature of −18° C. These preservation conditions must be kept even when the precooked dough is transported from the place where it was prepared to the place where the final product is going to be prepared, which is the bread that will be offered to the consumer.

When it is desired to prepare the final product, i.e. the bread ready for consumption, the piece of precooked dough is removed from the freezer and left to thaw in a refrigeration chamber at between 0° C. and 5° C. for at least 6 hours. As previously mentioned, one of the characteristics of the precooked dough according to the invention is that said dough may be kept in refrigeration, at for example 5° C., for at least 15 days without the organoleptic characteristics of the final product being altered such that the bread obtained will not be acceptable to the consumer. However, it is recommended that said precooked dough is not kept in refrigeration (5° C. at the most) for more than 10 days.

When it is desired to obtain the bread ready for consumption, the thawed precooked dough is subjected to the final baking process. As mentioned, this may take place at a high temperature in comparison with the standard temperatures at which this process is carried out: 230° C.-265° C. for a period of between 2 minutes and 3 minutes 30 seconds. Said method is preferably carried out in a convection oven. Baking is preferably carried out at specifically 240° C. for 3 minutes and 30 seconds.

This baking process produces bread ready for consumption. However, the process preferably includes a final step, in order for the bread consumed by the client to be in optimum conditions; in this process the bread is subjected to a final heating using a lamp at 70° C. for 30 seconds to 1 minute.

The bread obtained by applying the method according to the invention having all the steps described, including the steps relating to freezing and thawing as well as baking, will have specific characteristics in terms of, for example, level of hydration, strength of the crumb, alveolar structure, color of the crumb, thickness of the crust and color thereof, which directly depends on the conditions applied in the method according to the invention as well as on the starting ingredients and the proportion thereof. The bread obtained by applying the entire method according to the invention, including the steps of final heating, also constitutes an additional aspect of the present invention.

The bread obtained by applying the method according to the invention with all the steps described, including all the intermediate steps necessary for the preservation of the dough, is a bread with a cream-colored crumb and a reddish, crunchy crust with an approximate crust thickness of 1 mm-1.2 mm.

FIG. 2 shows photographs of pieces of bread obtained by applying the method according to the invention. FIG. 2a specifically shows pieces of bread in which the characteristics of the bread obtained may be seen, these pieces of bread being 36 g-44 g in weight, 12 cm-14 cm in length, 4 cm-5 cm in width and 2.8 cm-3.2 cm in height. In order to clearly show the qualities of the crust and crumb, two pieces of bread are shown which have already been cut along their full width. The specific details regarding their production are described in the Example presented further on.

Owing to its excellent organoleptic characteristics, in particular odor, taste and texture sensation when tasted in the mouth, the bread may be consumed as is, without further additives. Given that in one of the implementations of the invention, the precooked dough is preferably cut laterally with a hinge of 10% in the cooling stage, one of the preferred uses of the final bread according to the invention is in the preparation of sandwiches. To this end, the final cut may be carried on the piece of bread prior to it being filled, such that the “hinge” joining the two parts (the base and the upper part) is removed. This may be carried out with a knife, after which another foodstuff may be placed on the dough or an edible cream or paste may be spread on the part of one, or on both portions, of the piece corresponding to the crumb. However, this cut is preferably not carried out in order that both halves remain joined and losses of filling are avoided. It may also be consumed by pouring oil over the crust or over the crumb, once it has been opened.

In the event that the piece of baked bread is used for preparing sandwiches, in particular small montadito type sandwiches, it is recommended that the final heating using a lamp at 70° C., is carried out once the sandwich has been prepared, that is to say, once there is a product, which has a foodstuff between the base of the piece of bread and the upper part thereof, in order for it to reach the consumer in optimum conditions. As a result, greater homogenization between the temperature of the bread and the ingredients used as filling for the montadito or other sandwich is achieved.

In order to prevent ageing, it is not recommended for the already baked bread to be kept at room temperature for more than 40 minutes. If this case arises, an optional step may be carried out to rejuvenate the bread. In this step, the bread is subjected, once again, to a high temperature for a short time. The temperature is preferably kept at 265° C. for a period of 30 seconds to 1 minute. The possibility of carrying out this rejuvenation step by heating in a rapid manner, thereby obtaining a bread having a texture, crumb and crust which are not carbonized, but in good condition to be consumed, is another of the advantages of the bread according to the present invention and the method for producing the same.

As previously mentioned, the ingredients and concentrations thereof in the formulation according to the invention, in particular the characteristics of the flour and of the improvers, are significant in order that the precooked dough obtained therefrom has characteristics allowing it to readily tolerate the subsequent freezing and thawing conditions, without either process negatively affecting the organoleptic characteristics of the bread obtained therefrom. They are also significant in providing said precooked dough with the characteristics of being capable of remaining in refrigeration for longer than usual as well as with the possibility of being subjected to a final baking process at a higher than normal temperature, consequently in a faster manner, producing, in spite of this, a bread having organoleptic characteristics which are very appealing to the consumer. This precooked dough bread may be considered an intermediate product, the characteristics of which are closely related to the characteristics of the final product sought, i.e. the bread, which will have the final characteristics of color, taste, texture, smell, preservation, etc., which will directly depend on the characteristics of the precooked bread dough from which it is prepared.

In view of all of the above, the pieces of precooked bread dough obtained from the formulation according to the invention constitute another aspect of the invention. Another subject matter of the invention is, thus, a piece of precooked bread dough obtained from the following formulation:

| | |
|---|---|
| Wheat flour | 100 kg |
| Water | 55.7 kg-58 kg |
| Salt | 1.8 kg |
| Yeast (Saccharomyces cerevisiae) | 0.8 kg-1.2 kg |
| Improver | 0.7 kg-1.2 kg |

wherein the flour has a strength of 230 mm-275 mm and a ratio of tenacity to extensibility (P/L) comprised in the range of 0.5-0.75 and the improver comprises:

hemicellulase: <5% (weight/weight)

alpha-amylase: <5% (weight/weight)

ascorbic acid: <5% (weight/weight)

L-cysteine: <5% (weight/weight) an emulsifier and an anticaking agent.

As mentioned previously, the flour in the starting formulation according to the present invention preferably has a protein concentration of 12%-13% and a moisture content not exceeding 15%. The value of 12.8% is particularly preferred for the protein concentration. With regard to the ratio of tenacity to extensibility (P/L), as already mentioned, 0.55 is a suitable guideline value. With regard to the strength, as has also already been mentioned, 270 mm is a value suitable for the purposes of the invention. As already mentioned, 0.95 kg to 1.05 kg per 100 kg of flour is the preferred range for the amount of improver in the starting formulation. The emulsifier E472e and the anticaking agent E170i are preferably contained in this improver.

The improver may also comprise wheat flour (preferably 36%-44% (weight/weight) of improver) and wheat semolina (preferably 28%-36% (weight/weight) of improver).

Table 1, shown previously, shows preferred percentage ranges for the ingredients of the improver. In addition, in the Example shown further on, an improver composition is used in which the ingredients are measured out for 100 kg of flour, 1000 g (1 kg) of improver. A specific possible composition of the improver is also detailed in said Example.

Even starting from this defined formulation, the characteristics of the precooked bread dough as well as those of the bread obtained also starting therefrom, are linked to the conditions, under which the steps in obtaining them are carried out (dosage, kneading, resting, shaping, fermentation, making cuts in the surface, precooking and cooling), which will determine many of its characteristics as well as those of the bread ultimately obtained from this bread dough. Therefore, a preferred embodiment of this aspect of the invention, that of the bread dough, is one in which the piece of precooked bread dough is obtained by applying, to the starting formulation, the steps of the method according to the invention with all the possible embodiments and preferences previously mentioned and thereby producing a precooked bread dough. The embodiment which is particularly preferred is the one in which the piece of precooked bread dough has all the characteristics of weight and size enabling a piece of bread to be obtained having the shape and size sought, that is to say, a piece of precooked bread dough having: 36 g-44 g in weight, 12.8 cm±0.7 cm in length, 4.4 cm±0.3 cm in width and 2.9 cm±0.2 cm in height.

The final bread obtained from this precooked bread dough is logically another subject matter of the invention and constitutes another aspect thereof. However, apart from the key significance of the starting bread dough, the characteristics of the final bread obtained will also be conditioned by the final steps carried out to produce the latter and, as in the case of the dough bread, many of these characteristics will be difficult to define if they are not related to the method by which they are obtained. A particularly preferred embodiment of the bread according to the invention is thus, logically, that of the bread obtained from the precooked bread dough according to the invention, subjecting it to freezing, thawing, preservation in the refrigerator and final baking under the conditions previously specified for the method according to the invention.

The pieces of bread according to the invention are particularly well suited for preparing sandwiches, in particular, small sandwiches called montaditos. The use of the bread according to the invention for preparing sandwiches, in particular small sandwiches called montaditos, is, therefore, also an aspect of the invention. Prior to preparing said sandwiches, it is possible, for ease of handling, to cut the pieces of bread completely, along their entire width, thereby removing the so-called “hinge” that kept the base and the upper of the pieces joined. However, this cutting is preferably not carried out and the pieces of bread are filled without removing the hinge, thereby avoiding any loss of filling added and reducing the risk of the upper part of the sandwich separating and becoming lost while transporting the sandwich to the consumer, in particular when they are small sandwiches such as montaditos.

Additionally, in order that the sandwiches are of the highest possible quality and that the consumer may recognize them as such, it is particularly preferred and optional to carry out a final heating step on the sandwiches, when they have been prepared and prior to serving them, using a lamp at 70° C. for between 30 seconds and 1 minute, thereby homogenizing the temperature of the bread and that of the ingredient used as the filling. These final heating conditions are suggested, in particular, for the small montadito type sandwiches.

In order to outline the characteristics of the invention with the greatest possible clarity, one case for preparing breads according to the invention such as those depicted in FIG. 2a is explained in detail below.

### Example

As previously mentioned, the pieces of bread shown in FIG. 2a were produced following the method according to the invention. To this end, the method according to the invention was carried out in the following manner:

a) Dosage:

| | |
|---|---|
| Wheat flour | 100 kg |
| Water | 55.7 kg in total |
| Salt | 1.8 kg |
| Yeast (Saccharomyces cerevisiae) | 0.8 kg |
| Improver | 1.0 kg |

wherein:
the flour has a strength of 270 mm, a ratio of tenacity to extensibility (P/L) of 0.55, a protein concentration of 12.% and a maximum moisture content of 15%;
the 1000 grams (1 kg) of improver, supplied by EuroGerm (Abrera, Barcelona, Spain) include:

| | |
|---|---|
| 397 g of flour | (39.7% of 1000 g) |
| 332 g of wheat semolina | (33.2% of 1000 g) |
| 0.48 g of hemicellulase | (0.048% of 1000 g) |
| 0.24 g of alpha-amylase | (0.024% of 1000 g) |
| 1 g of ascorbic acid | (0.1% of 1000 g) |
| 0.28 g of L-cysteine | (0.028% of 1000 g) |
| 143 g of the emulsifier, E472e | (14.3% of 1000 g) |
| 126 g of the anticaking agent, E170i | (12.6% of 1000 g) |

The list of ingredients were poured over deposits prepared to weigh liquids or solids, controlled by Ramsey™ devices, which continuously verify that the formula in-process is correctly measured out. When it has been verified, it is measured into a device to be premixed.

b) Kneading

Kneading was carried out after the previous premixing at 100 mm/min in a Sancassiano™ device. From there, it was passed to the kneader wherein the kneading was carried out for 5.6 minutes in a Continuous Force model spiral kneader from Sancassiano. This kneader has 5 cavities and each cavity has a spiral which operates at a speed of 165 mm/min with a head which moves at 0.177 (rotation/min). This device also automatically regulates the temperature by means of a glycol system. At this point in the process, the dough is refined in order to be able to be made into bread without problems.

The dough leaves the kneader, continuously and in portions, through the lower part, discharging onto a belt to pre-rest. The temperature of the final dough was 23.7° C.

c) Resting

Resting time on the belt: 5 minutes

d) Shaping

Shaping was carried out in a divider machine with two outlet channels, from each one of which the pieces exited, separated from the portions of dough arriving to the machine (bulk dough). The specific details of the functioning of the machine were as follows:
Dividing rate (strokes/min): 75
Bulk dough weight (g): 182±3
Line rate (pieces/min): 75×4
Piece weight (g): 45.5±2
Units per tray (pieces×channel): 88 (4×22)
Piece length (cm): 12.3±0.3
Piece width (cm): 2.6±0.2 The trays with the divided pieces were brought to the fermentation chamber by means of a belt system.

e) Fermentation

Fermentation was carried out in a MECATHERM™ chamber with 6 modules, under the following conditions:
Fermentation temperature (° C.): 25° C. (+1° C.)
Humidity per module (%): module 1; module 2; module 3: 50-50-50 (±5)
Number of modules: 6
Fermentation time: 112±2.0 minutes
Length of piece (cm): 12.8±0.7
Width of piece (cm): 3.5±0.2

The fermented pieces were guided directly towards a cutting area.

f) Cutting on surface

The cuts were carried out with a TIPO VISTURI knife. Two oblique parallel cuts were made on the surface of each piece.

g) Precooking

Precooking was carried out in a MECATHERM™ type oven, with two modules and with a variable firing curve having the following characteristics:
Firing curve (° C.): module 1: 165-180; module 2: 175-160
Vapor (%): module 1: 7±3; module 2: 0
Draw (%): 40±10
Precooking time (min): 15.5
Internal temperature of the product upon leaving the oven (° C.): 85±2

h) Cooling

Cooling is the stage during which the lateral cut with a hinge of 10% was carried out on the pieces.
Cooling time (min): 20±0.5
Hinge type: lateral 10%
Piece length (cm): 12.8±0.7
Piece width (cm): 4.4±0.3
Piece height (cm): 2.9±0.2
Internal temperature of the product upon entering the freezer (° C.): 57±3

i) Freezing

Freezing was carried out in a MECATHERM™ chamber, under the following conditions:
Time (min): 37
Freezing temperature (° C.): −25±1
Internal temperature of the product upon exiting the freezer (° C.): −9±3.

In this case, the precooked pieces were kept frozen for 1 month prior to carrying out thawing. The pieces were at a temperature below −18° C. at all times.

j) Thawing

Thawing took place over 6 hours at 5° C., after which the pieces were kept in the refrigerator for 10 days at 5° C.

k) Baking

Baking took place in a convection oven, which was kept on for at least 10 minutes prior to introducing the pieces into the same.

The bread was placed on trays in the oven, such that they were arranged perpendicular to the oven fans so as to achieve a homogenous baking/cooking and the correct caramelization of the crust.
Baking temperature: 240° C.
Baking time: 3 minutes 30 seconds

l) Optional final cut

Using a standard kitchen knife.

FIG. 2a shows two pieces already cut.

### BRIEF DESCRIPTION OF THE FIGURES

FIG. 1 shows a schematization of a typical alveograph, in which the rheological parameters were determined after carrying out various tests. It is indicated from where the values are deduced: tenacity (value P, corresponds to the mean of the maximum y-axes), extensibility (L, corresponds to the mean value of the x-axes at the breakage point of the dough), stretch or strength of the dough (W corresponds to the area comprised below the curve and delimited by the x- and y-axes and the vertical line traced from the x-axis corresponding to the mean L value up to the y-axis value of the curve at this point) and flexibility (corresponds to the height value of the curve at the point determining the mean length of L). The x-axes corresponding to the times at which the dough breaks in each of the experiments are also indicated (“breakage point”).

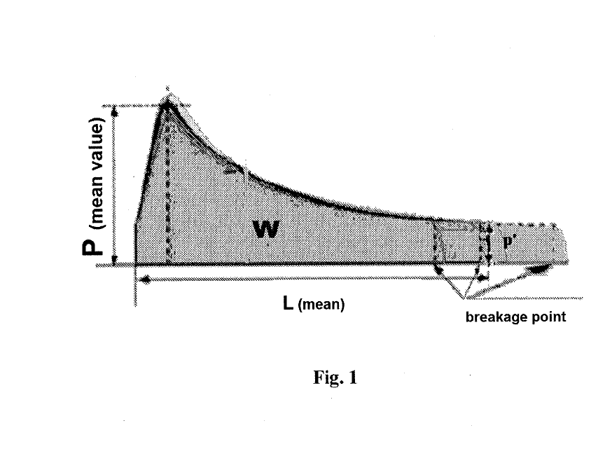

FIG. 2 shows photographs of the pieces of bread obtained by applying the method according to the invention:
FIG. 2a corresponds to two pieces of 36 g-44 g in weight, 12 cm-14 cm in length, 4 cm-5 cm in width and 2.8 cm-3.2 cm in height, cut along their whole width. On the left-hand side of the photograph, the upper portions of the pieces are shown, positioned such that the part of the crust is shown, while on the right-hand side of the photograph, the bases of the pieces are shown, positioned such that the crumb may be seen.
FIG. 2b shows a photograph of a piece of bread obtained by applying the method according to the invention, in which the optional step of marking the pieces after precooking using a laser has been carried out. The distinctive sign, “100M” may be seen near the left end, specifically, below the slit.

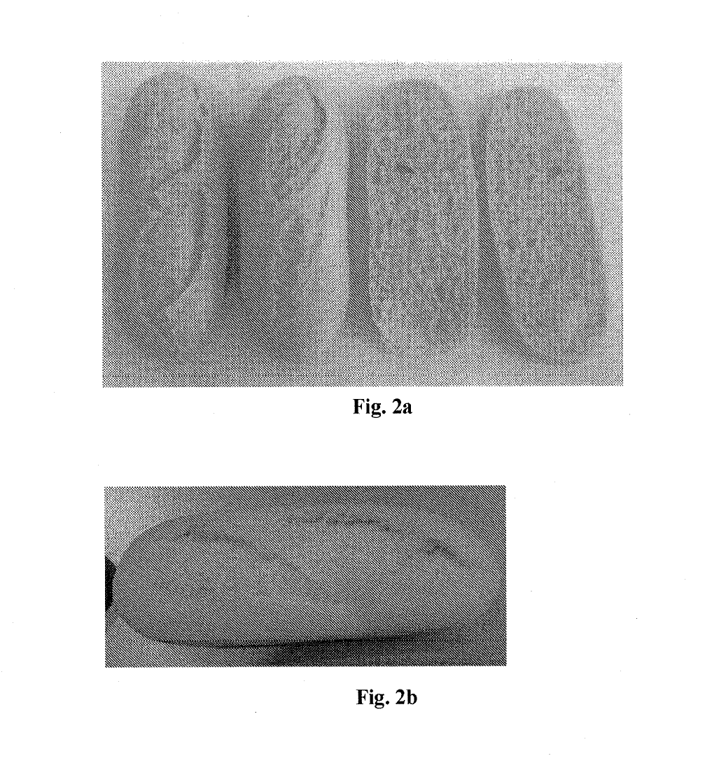

1. A method for preparing bread comprising the following steps:
(a) measuring out the following ingredients into a container:

| | |
|---|---|
| Wheat flour | 100 kg |
| Water | 55.7 kg-58 kg |
| Salt | 1.8 kg |
| Yeast (Saccharomyces cerevisiae) | 0.8 kg-1.2 kg |
| Improver | 0.7 kg-1.2 kg |

wherein the flour has a strength of 230 mm-275 mm and a ratio of tenacity to extensibility (P/L) comprised in the range of 0.5-0.75 and wherein the improver comprises:
hemicellulase: <5% (weight/weight)
alpha-amylase: <5% (weight/weight)
ascorbic acid: <5% (weight/weight)
L-cysteine: <5% (weight/weight) an emulsifier and an anticaking agent;
(b) kneading the mixture of the above ingredients;
(c) leaving the dough to rest;
(d) shaping individual pieces from the dough;
(e) leaving the dough to ferment;
(f) making cuts on the surface of the fermented dough;
(g) precooking the fermented dough;
(h) cooling.

2. The method according to claim 1, comprising an additional step, after the precooking step (g), of marking the precooked dough.

3. Method according to claim 1, wherein the flour has a protein concentration of 12-13% and a moisture content not exceeding 15%.

4. Method according to claim 3, wherein the flour has a protein concentration of 12.8%, a strength of 270 mm and a ratio of tenacity to extensibility (P/L) of 0.55.

5. Method according to claim 1, wherein the improver is measured out into an amount of 0.95 kg to 1.05 kg per 100 kg of flour.

6. Method according to claim 1, wherein the improver further comprises wheat flour and wheat semolina.

7. Method according to claim 1, wherein the emulsifier present in the improver is E472e and the anticaking agent is E170i.

8. Method according to claim 7, wherein the improver comprises the following ingredients:

| | |
|---|---|
| Wheat flour | 36-44% (weight/weight) |
| Wheat semolina | 28-36% (weight/weight) |
| Emulsifier: E472e | 10-18% (weight/weight) |
| Anticaking agent: E170i | 8-16% (weight/weight) |
| Ascorbic acid + L-cysteine | ≦5% (weight/weight) |
| Enzymes: hemicellulase + alpha-amylase | ≦5% (weight/weight). |

9. Method according to claim 8, wherein the amounts of the ingredients, per 100 kg of wheat flour, are as follows:

| | |
|---|---|
| Wheat flour | 100 kg |
| Water | 55.7 kg |
| Salt | 1.8 kg |
| Yeast (Saccharomyces cerevisiae) | 0.8 kg |
| Improver | 1.0 kg |

and wherein the improver has the following composition:

| | |
|---|---|
| Wheat flour | 39.7% |
| Wheat semolina | 33.2% |
| Hemicellulase | 0.048% |
| Alpha-amylase | 0.024% |
| Ascorbic acid | 0.1% |
| L-cysteine | 0.028% |
| Emulsifier E472e | 14.3% |
| Anticaking agent E170i | 12.6% |

10. Method according to claim 1, wherein the individual pieces preformed from the dough in step (d) do not exceed 50 grams in weight.

11. Method according to claim 10, wherein the steps (b) to (h) of the method are carried out under the following conditions:
(b) kneading for 5.6±3 minutes, in a spiral kneader which rotates at 165±5 rpm;
(c) leaving the dough to rest for 5±3 minutes;
(d) shaping individual pieces from the dough in rectangular pieces of 45.5±2 grams;
(e) leaving the dough to ferment for 112±2 minutes at 25° C.±1° C.;
(f) making cuts on the surface of the fermented dough, said cuts being 2 oblique cuts;
(g) precooking the fermented dough for 15.5 minutes, in two modules, each one of which being of the same duration, wherein the temperatures vary in the following way: module 1 starts at 165° C., increases up to 180° C. and the temperature decreases again to 165° C.; module 2 starts at 165° C., increases up to 175° C. and the temperature is allowed to decrease to 160° C., and wherein the vapor percentage in module 1 is 7±3% and in module 2 is 0%.
(h) cooling for 20±0.5 minutes, at room temperature.

12. Method according to claim 11, wherein step (h) comprises precutting the precooked dough obtained in step (g), making a lateral cut with a hinge of 10%.

13. Method according to claim 11, comprising an additional step, after the precooking step (g), in which the precooked dough is marked by means of a 100 W laser system.

14. Method according to claim 1, wherein the piece of precooked dough obtained in step (h) is subjected to freezing.

15. Method according to claim 14, wherein freezing is carried out for 37 minutes at −25° C.±1° C.

16. Method according to claim 14, wherein the piece of frozen precooked dough is kept at a temperature equal to or less than −18° C.

17. Method according to claim 16, wherein the piece of frozen precooked dough is kept at a temperature of between −22° C. and −18° C.

18. Method according to claim 14, wherein the piece of precooked dough is removed from the freezer and thaws at a temperature of between 0° C. and 5° C. for at least 6 hours.

19. Method according to claim 18, wherein the piece of thawed precooked dough is kept in refrigeration for at most 10 days.

20. Method according to claim 18, wherein the piece of thawed precooked dough is subjected to a final baking process at 230° C.-265° C. for a period of time between 2 minutes and 3 minutes and 30 seconds.

21. Method according to claim 20, wherein the final baking is carried out in a convection oven.

22. Method according to claim 20, wherein the final baking process is carried out at 240° C. for 3 minutes and 30 seconds.

23. Method according to claim 20, including a final step, wherein the bread, once filled, is subjected to heating using a lamp at 70° C. for 30 seconds to 1 minute.

24. A piece of precooked bread dough obtained from the following formulation:

| | |
|---|---|
| Wheat flour | 100 kg |
| Water | 55.7 kg-58 kg |
| Salt | 1.8 kg |
| Yeast (Saccharomyces cerevisiae) | 0.8 kg-1.2 kg |
| Improver | 0.7 kg-1.2 kg |

wherein the flour has a strength of 230-275 mm and a ratio of tenacity to extensibility (P/L) comprised in the range of 0.5-0.75 and the improver comprises:
Hemicellulase: <5% (weight/weight)
Apha-amylase: <5% (weight/weight)
Ascorbic acid: <5% (weight/weight)
L-cysteine: <5% (weight/weight)
an emulsifier and an anticaking agent.

25. Piece of precooked bread dough according to claim 24, wherein the starting flour formulation has a protein concentration of 12-13% and a moisture content not exceeding 15%.

26. Piece of precooked bread dough according to claim 25, wherein the starting flour formulation has a protein concentration of 12.8%, a strength of 270 mm and a ratio of tenacity to extensibility (P/L) of 0.55.

27. Piece of precooked bread dough according to claim 24, wherein the improver is present in the starting formulation in an amount of 0.95 kg to 1.05 kg per 100 kg of flour.

28. Piece of precooked bread dough according to claim 24, wherein the improver in the starting formulation further comprises wheat flour and wheat semolina.

29. Piece of precooked bread dough according to claim 24, wherein the emulsifier of the improver in the starting formulation is E472e and the anticaking agent is E170i.

30. Piece of precooked bread dough according to claim 29, wherein the improver in the starting formulation comprises the following ingredients:

| | |
|---|---|
| Wheat flour | 36-44% |
| Wheat semolina | 28-36% |
| Emulsifier: E472e | 10-18% |
| Anticaking agent: E170i | 8-16% |
| Ascorbic acid + L-cysteine | ≦5% |
| Enzymes: hemicellulase + alpha-amylase | ≦5%. |

31. Piece of precooked bread dough according to claim 30, obtained from a formulation in which the amounts of the ingredients per 100 kg of wheat flour are the following:

| | |
|---|---|
| Wheat flour | 100 kg |
| Water | 55.7 kg |
| Salt | 1.8 kg |
| Yeast (Saccharomyces cerevisiae) | 0.8 kg |
| Improver | 1.0 kg |

and wherein the improver has the following composition:

| | |
|---|---|
| Wheat flour | 39.7% |
| Wheat semolina | 33.2% |
| Hemicellulase | 0.048% |
| Alpha-amylase | 0.024% |
| Ascorbic acid | 0.1% |
| L-cysteine | 0.028% |
| Emulsifier E472e | 14.3% |
| Anticaking agent E170i | 12.6% |

32. Piece of precooked bread dough obtained by a method according to claim 1.

33. Piece of precooked bread dough according to claim 32, being 36-44 grams in weight, 12.8±0.7 cm in length, 4.4±0.3 cm in width and 2.9±0.2 cm in height.

34. A piece of bread obtained from a piece of precooked bread dough according to claim 24.

35. Piece of bread obtained by a method according to claim 14.

36. Piece of bread according to claim 32, the crust of which has a thickness of 1-1.2 mm.

37. Use of a piece of bread of claim 34 for the preparation of sandwiches.

38. Use according to claim 37, wherein small montadito type sandwiches are prepared.

39. Use according to claim 37, wherein the pieces of bread are completely cut along their entire width prior to preparing the sandwiches.

40. Use according to claim 37, wherein the upper part of the piece remains joined to the lower part by way of a hinge, which is maintained during the preparation of the sandwiches.

41. Use according to claim 37, wherein the sandwiches, prior to being served to the consumer, undergo a final heating step using a lamp at 70° C. for 30 seconds to 1 minute.

42. Use according to claim 41, wherein the sandwiches are small montadito type sandwiches.
